(19) United States
(12) Patent Application Publication
(10) Pub. No.: US 2016/0341996 A1
(43) Pub. Date: Nov. 24, 2016

(54) LIQUID CRYSTAL DISPLAY PANEL, MANUFACTURING METHOD THEREOF AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xiaojuan WU, Beijing (CN); Qian WANG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/136,270

(22) Filed: Apr. 22, 2016

(30) Foreign Application Priority Data
May 22, 2015 (CN) 201510266493.8

(51) Int. Cl. G02F 1/1339

(52) U.S. Cl. CPC G02F 1/1339; G02F 2201/086

(57) ABSTRACT

A liquid crystal display (LCD) panel, a manufacturing method thereof and a display device. The LCD panel includes an upper substrate, a lower substrate, liquid crystal molecules filled in a liquid crystal (LC) display area between the upper substrate and the lower substrate, and sealant sealed at edges of the upper substrate and the lower substrate. Ultraviolet (UV) absorption pigment configured for preventing UV light from entering into the LC display area is coated between the sealant and the LC display area.

### TECHNICAL FIELD

Embodiments of the present disclosure relate to a liquid crystal display (LCD) panel, a manufacturing method thereof and a display device.

### BACKGROUND

Narrow-bezel LCDs have become a research focus in the field of display due to the characteristics of aesthetic appearance, larger display screens, better user experience, etc. Currently, methods for achieving narrow bezels mainly includes GOA design adjustment, sealant zero-cutting, etc.

### SUMMARY

Embodiments of the present disclosure provide a liquid crystal display (LCD) panel. The LCD panel includes an upper substrate, a lower substrate, liquid crystal molecules filled in a liquid crystal (LC) display area between the upper substrate and the lower substrate, and sealant sealed at edges of the upper substrate and the lower substrate. Ultraviolet (UV) absorption pigment configured for preventing UV light from entering into the LC display area is coated between the sealant and the LC display area.

Embodiments of the present disclosure further provide a method for manufacturing an LCD panel. The method includes arranging an upper substrate and a lower substrate of the LCD panel, and forming the LCD panel by assembling the upper substrate and the lower substrate together, where the upper substrate and the lower substrate are arranged opposite to each other, liquid crystal molecules are disposed in an liquid crystal (LC) display area between the upper substrate and the lower substrate, and sealant is sealed at edges of the upper substrate and the lower substrate. The method further includes: before the assembling, coating UV absorption pigment between the sealant and the LC display area, the UV absorption pigment configured for preventing UV light from entering into the LC display area.

Embodiments of the present disclosure further provide a display device, which includes the LCD panel described above.

### BRIEF DESCRIPTION OF THE DRAWINGS

In order to illustrate the technical solutions in the embodiments of the present disclosure or the existing arts more clearly, the drawings need to be used in the description of the embodiments or the existing arts will be briefly described in the following; it is obvious that the drawings described below are only related to some embodiments of the present disclosure, for one ordinary skilled person in the art, other drawings can be obtained according to these drawings.

FIG. 1 is a schematic diagram of a partial view of a bezel of an LCD panel;

FIG. 2A is a schematic view of a partial structure of a bezel in an LCD panel provided by an embodiment of the present disclosure;

FIG. 2B is a top view of a LCD panel provided by an embodiment of the present disclosure;

FIG. 3A is a schematic view of a partial structure of a bezel in an LCD panel provided by another embodiment of the present disclosure;

FIG. 3B is a top view of an LCD panel provided by another embodiment of the present disclosure;

FIG. 3C is a top view of an LCD panel provided by another embodiment of the present disclosure;

FIG. 4A is a schematic view of a partial structure of a bezel in an LCD panel provided by yet another embodiment of the present disclosure; and

FIG. 4B is a top view of an LCD panel provided by yet another embodiment of the present disclosure.

### REFERENCE NUMERALS OF THE ACCOMPANYING DRAWINGS

1—upper substrate; 2—black matrix (BM); 3—LC display area; 4—lower substrate; 5—mask plate; 6—sealant; 7—ultraviolet (UV) absorption pigment ring (coated at a non-mask coverage area); 70—UV absorption pigment ring (coated at a mask coverage area); a—distance from an outer edge of the mask plate to the display area, b—distance from the outer edge of the mask plate to an inner edge of the sealant, c—sealant width, d—cutting accuracy, e—bezel size of the LCD panel, where e=a+b+c+d.

### DETAILED DESCRIPTION

Hereafter, the technical solutions of the embodiments of the present disclosure will be described in a clearly and fully understandable way in connection with the drawings related to the embodiments of the invention. It is obvious that the described embodiments are just a part but not all of the embodiments of the present disclosure. The drawings mentioned in the embodiments of the present disclosure are only to exemplarily illustrate the technical solutions of the present disclosure. The other drawings obtained from the drawings of the embodiments of the present disclosure through simple transformations should be within the scope of the present disclosure.

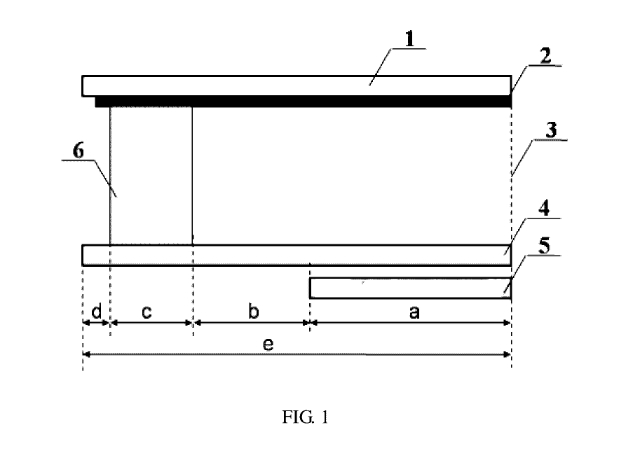

FIG. 1 is a schematic diagram of a bezel of an LCD panel. The bezel size e of the LCD panel is generally determined by a sealant width c, a cutting accuracy d, a distance b from an outer edge of a mask plate 5 to an inner edge of the sealant 6, and a distance a from the outer edge of the mask plate 5 to a display area (e.g., e=a+b+c+d). The sealant is generally a resin composition, including UV polymerizable monomers, and may be photo-cured under the irradiation of UV light (with the wavelength of 320-380 nm). However, as liquid crystals at the edge of the display device tend to be denatured due to the irradiation of the UV light within the above wavelength range, the distance “a” (usually more than 0.2 mm) from the outer edge of the mask plate to the display area may need to be increased, causing that an ultra-narrow bezel may not be achieved in the display device. A related technical solution may generally include developing liquid crystal materials which are resistant to UV irradiation, but this solution incurs a high cost and has limited effect.

An embodiment of the present disclosure provides an LCD panel, which includes an upper substrate, a lower substrate, liquid crystal molecules filled between the upper substrate and the lower substrate, and a sealant sealed at the edges of the upper substrate and the lower substrate. UV absorption pigment that is capable of preventing UV light from entering into an LC display area may be coated between the sealant and the LC display area that is filled with the liquid crystal molecules.

In an embodiment of the present disclosure, by simply coating the UV absorption pigment that is capable of preventing the UV light from entering into the liquid crystal (LC) display area between the sealant and the LC display area, when the sealant is subjected to UV irradiation, the UV absorption pigment disposed between the sealant and the LC display area can absorb UV light which may enter into the LC display area, so that irradiation of the UV light on the liquid crystal molecules in the LC display area can be avoided, and hence the distance from the outer edge of the UV photo-curing mask plate to the LC display area can be reduced (for instance, suppose that no UV absorption pigment is provided. In order to prevent the UV light from affecting the LC display area, the mask plate may need to extend outside the LC display area for a longer distance, causing a larger distance “a”). Therefore, the bezel width of the LCD panel can be reduced, and hence the ultra-narrow-bezel LCD device can be conveniently achieved.

For instance, the UV absorption pigment is coated in a shape of one or more strips or a ring. In an embodiment of the present disclosure, the coating approach of the UV absorption pigment can be determined according to actual needs, e.g., a single-side strip coating or a symmetric two-side strip coating. Or, the UV absorption pigment may be coated on the circumference in a form of a ring to form an UV absorption ring, so that the widths of the four sides of the bezel can be reduced simultaneously, and hence a better ultra-narrow bezel can be achieved. In addition, in an embodiment of the present disclosure, the bezel width of the LCD device can be adjusted by adjusting the number of strips or rings of the UV absorption pigment and positions of the strips or rings according to actual needs.

The UV absorption pigment provided by an embodiment of the present disclosure may be made from a plurality of materials that are capable of absorbing UV light. For instance, (E)-6-(4-(4-(ethane-sulfonyl)styryl)phenoxy)ethane-1-alcohol may be adopted to achieve better UV absorption effect, and this UV absorption pigment can absorb UV light with the wavelength of 320 to 380 nm.

A structural expression of the (E)-6-(4-(4-(ethane-sulfonyl)styryl)phenoxy)ethane-1-alcohol can be as follows:

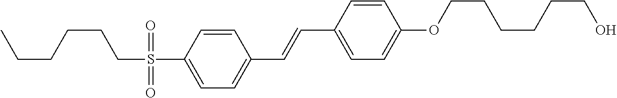 [SMILES: CCCCCCS(=O)(=O)c1ccc(/C=C/c2ccc(OCCCCCCO)cc2)cc1]

The above compound may be prepared by a conventional method. For instance, a reaction mechanism of (E)-6-(4-(4-(ethane-sulfonyl)styryl)phenoxy)ethane-1-alcohol can be as follows:

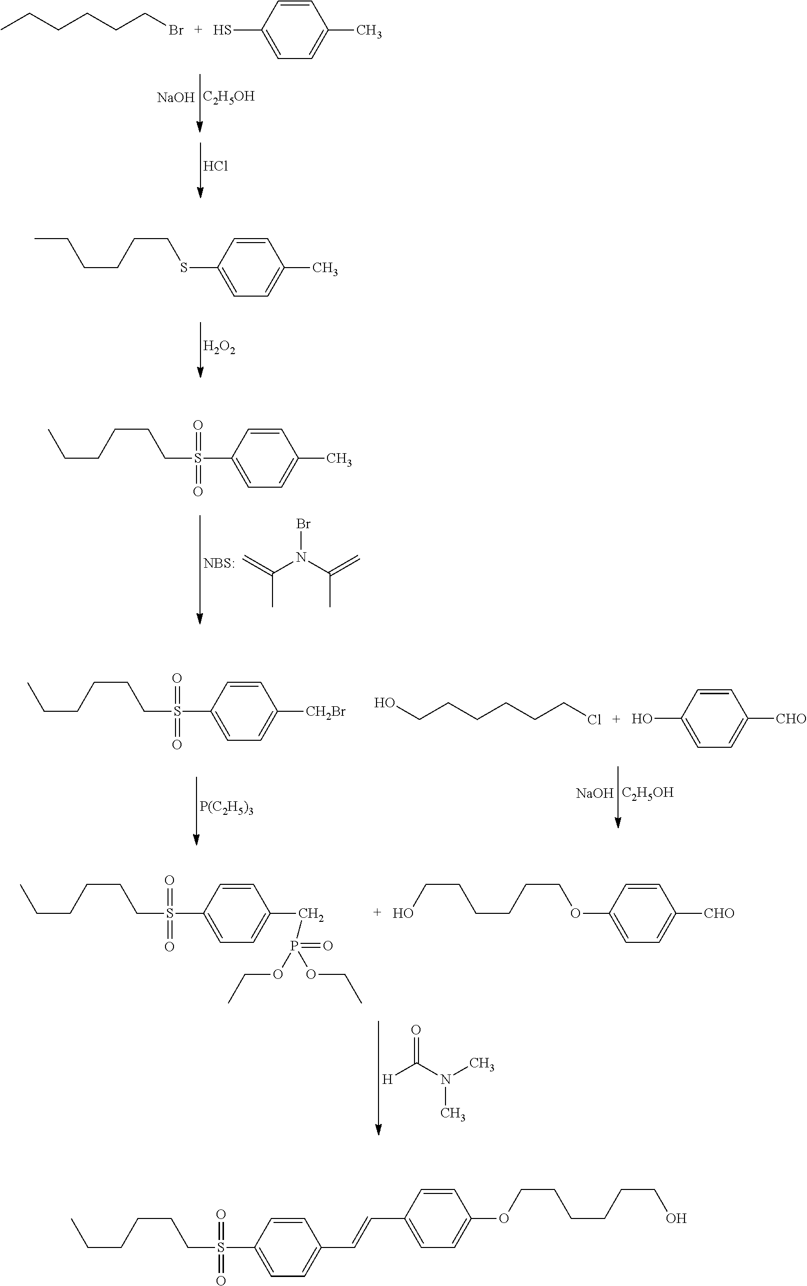

For instance, a coating width of the UV absorption pigment can be 10 to 100 μm, and a thickness of the UV absorption pigment can be 2.0 to 6.0 μm. The UV absorption pigment with this dimension can achieve better UV absorption effect.

For instance, a distance from the coating position of the UV absorption pigment to the sealant can be greater than or equal to 50 μm (e.g., >50 μm). The coating position satisfying this distance range will not affect the curing of the sealant.

For instance, the UV absorption pigment can be coated at a non-mask coverage area between the sealant and the LC display area. Or, the UV absorption pigment can be coated at a mask coverage area between the sealant and the LC display area. Or, the UV absorption pigment can be coated at both the mask coverage area and the non-mask coverage area between the sealant and the LC display area. Different coating positions of the UV absorption pigment can all achieve the UV absorption effect.

For instance, the UV absorption pigment can be respectively coated at the mask coverage area and the non-mask coverage area. The coexistence of the respective coating of the UV absorption pigment at the mask coverage area and the non-mask coverage area can reduce the bezel width to a greater extent.

An embodiment of the present disclosure further provides a method for manufacturing an LCD panel, which includes: arranging an upper substrate and a lower substrate of the LCD panel and assembling the upper substrate and the lower substrate to form the LCD panel. The upper substrate and the lower substrate are disposed opposite to each other. Liquid crystal molecules are filled between the upper substrate and the lower substrate. Sealant is sealed at the edges of the upper substrate and the lower substrate. The method further includes the step of coating UV absorption pigment between the sealant and the LC display area before the assembling. The UV absorption pigment is capable of preventing UV light from entering into the LC display area that is provided with the liquid crystal molecules.

The UV absorption pigment coated between the sealant and the display area can absorb UV light which may enter into the LC display area. For instance, when the sealant is subjected to UV irradiation, the UV absorption pigment disposed between the sealant and the LC display area can absorb UV light which may enter into the LC display area, so that irradiation of the UV light on the liquid crystals in the LC display area can be avoided, and hence the distance from the outer edge of the UV photo-curing mask plate to the LC display area can be reduced (for instance, on the contrary, suppose that no UV absorption pigment is provided. In order to prevent the UV light from affecting the LC display area, the mask plate may need to extend outside the LC display area for a longer distance, causing a larger distance “a”). Therefore, the bezel width of the LCD panel can be reduced, and hence the ultra-narrow-bezel LCD device can be conveniently achieved

For instance, the UV absorption pigment is (E)-6-(4-(4-(ethane-sulfonyl)styryl)phenoxy)ethane-1-alcohol.

For instance, the UV absorption pigment is coated after being dissolved in an organic solvent. Dissolution of the UV absorption pigment makes coating easier.

For instance, the organic solvent may include one or more of dichloromethane, trichloromethane and acetone. For instance, the organic solvent is dichloromethane. The UV absorption pigment can be fully dissolved in the solvent, which makes coating easier.

For instance, a mixed mass ratio of the UV absorption pigment to the organic solvent is in a range between 1:9 and 6:4. The coating effect of the UV absorption pigment in this range is better than that in other ranges.

For instance, the method further includes the step of performing deaeration on the sealant and the UV absorption pigment before use. The sealant and the UV absorption pigment after deaeration have better coating effect. For instance, the deaeration process may including placing the sealant and the UV absorption pigment in a deaeration machine to perform deaeration for 1 to 4 hours (e.g., 2-4 hours), respectively.

Detailed description will be given to the technical solutions of the present disclosure with reference to different embodiments.

### Embodiment 1

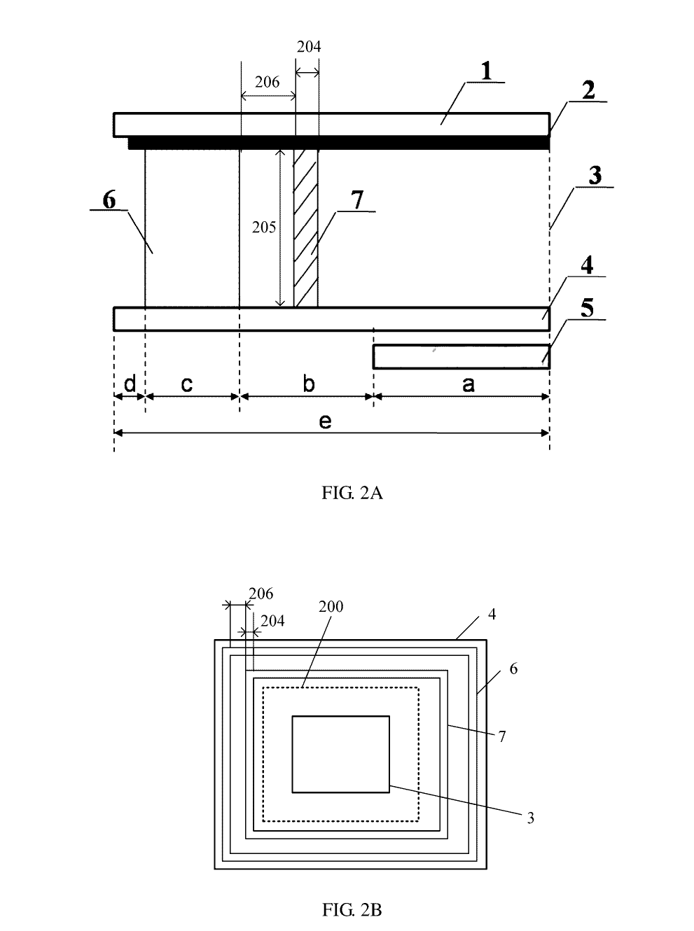

The embodiment provides an LCD panel, as illustrated in FIG. 2A, which includes an upper substrate 1 (including a black matrix 2), a lower substrate 4, an LC display area 3 provided between the upper substrate and the lower substrate, and sealant 6 sealed at the edges of the upper substrate 1 and the lower substrate 4. In this case, a UV absorption pigment ring 7 capable of preventing UV light from entering into the LC display area 3 is coated between the sealant 6 and the LC display area 3. The UV absorption pigment ring 7 is coated at a non-mask coverage area.

In the embodiment, the UV absorption pigment is (E)-6-(4-(4-(ethane-sulfonyl)styryl)phenoxy)ethane-1-alcohol.

As illustrated in FIGS. 2A and 2B, a coating width 204 of the UV absorption pigment ring 7 is 10 to 100 μm, and a thickness 205 of the UV absorption pigment ring 7 (that is, a longitudinal length of the UV absorption pigment ring 7 in FIG. 2A) is 2.0 to 6.0 μm. A distance 206 from a coating position of the UV absorption pigment ring 7 to the sealant 6 is greater than or equal to 50 μm. The coating position of the UV absorption pigment ring 7 satisfying this distance range will not affect the curing of the sealant. The UV absorption pigment ring 7 is coated at the non-mask coverage area (e.g., at a position outside a mask coverage area 200).

### Embodiment 2

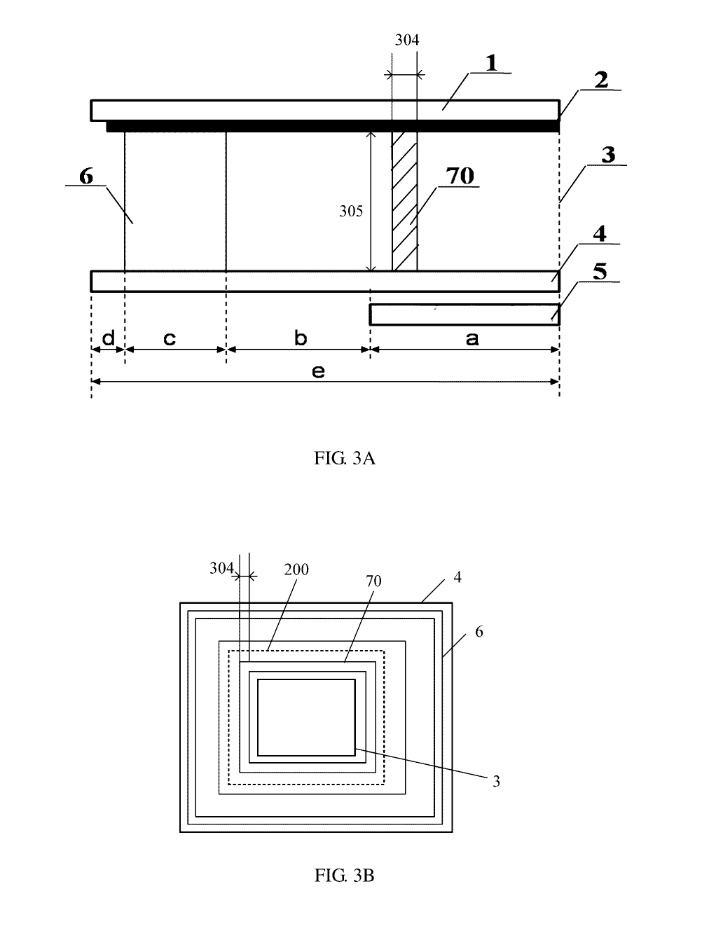

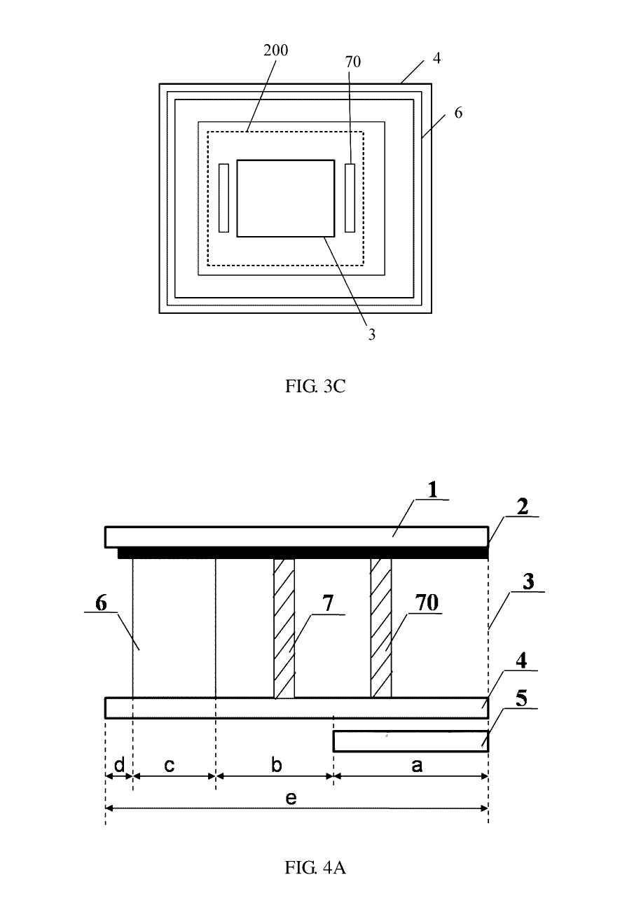

The embodiment provides an LCD panel, which, as illustrated in FIG. 3A, includes an upper substrate 1, a lower substrate 4, an LC display area 3 filled between the upper substrate and the lower substrate, and sealant 6 sealed at the edges of the upper substrate 1 and the lower substrate 4. In this case, a UV absorption pigment ring 70 capable of preventing UV light from entering into the LC display area 3 is coated between the sealant 6 and the LC display area 3. The UV absorption pigment ring 70 is coated at a mask coverage area.

In the embodiment, the UV absorption pigment is (E)-6-(4-(4-(ethane-sulfonyl)styryl)phenoxy)ethane-1-alcohol.

As illustrated in FIG. 3B, a coating width 304 of the UV absorption pigment ring 70 is 10 to 100 μm, and a coating thickness of the UV absorption pigment ring 70 is 2.0 to 6.0 μm. The UV absorption pigment ring 70 is coated inside a mask coverage area 200.

### Embodiment 3

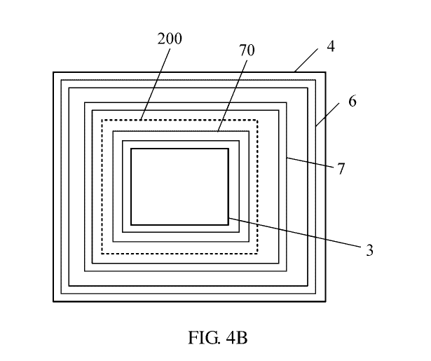

The difference between the embodiment 3 and the embodiments 1 and 2 includes that: in the embodiment 3, UV absorption pigment rings 7 and 70 capable of preventing UV light from entering into the LC display area are coated between the sealant 6 and the LC display area 3, where the UV absorption pigment ring 7 is coated at a non-mask coverage area, and the UV absorption pigment ring 70 is coated at a mask coverage area (as illustrated in FIGS. 4A and 4B).

### Embodiment 4

The difference between the embodiment 4 and the embodiment 1 includes that: in the embodiment 3, a width 204 of the UV absorption pigment ring 7 is 10 μm, and the thickness 205 of the UV absorption pigment ring 7 is 6 μm, and the distance from the UV absorption pigment ring 7 to the sealant is 50 μm.

### Embodiment 5

The difference between the embodiment 5 and the embodiment 2 includes that: in the embodiment 5, the UV absorption pigment 70 is coated in a form of strips (a symmetric two-side strip coating); the width of each UV absorption pigment strip is 20 μm, and the thickness of each UV absorption pigment strip is 2 μm; and the distance from a UV absorption pigment strip to the sealant 6 is 200 μm (as illustrated in FIG. 3C).

### Embodiment 6

The difference between the embodiment 6 and the embodiment 3 includes that: in the embodiment 6, the widths of the UV absorption pigment rings 7 and 70 are respectively 35 μm and 15 μm, and the thickness of each of the UV absorption pigment rings 7 and 70 is 2 μm; the distance from the UV absorption pigment ring 7 at the non-mask coverage area to the inner edge of the sealant is 60 μm; and a spacing distance between the UV absorption pigment ring 7 and the UV absorption pigment ring 70 is 50 μm.

### Embodiment 7

The embodiment provides a method for manufacturing an LCD panel, which includes:

(1) arranging an upper substrate and a lower substrate of a display device;
(2) coating sealant at edges of the upper substrate and coating UV absorption pigment between the sealant of the upper substrate and an LC display area in a form of a ring; and
(3) assembling the upper substrate and the lower substrate, filling liquid crystal molecules in the LC display area, and performing UV photocuring and thermal curing on the display device.

### Embodiment 8

The difference between the embodiment 8 and the embodiment 7 includes that: in the embodiment 8, the UV absorption pigment is (E)-6-(4-(4-(ethane-sulfonyl)styryl)phenoxy)ethane-1-alcohol; and before coating, (E)-6-(4-(4-(ethane-sulfonyl)styryl)phenoxy)ethane-1-alcohol and dichloromethane are uniformly mixed according to a mass ratio (or a volume ratio) of 70% to 30% and placed in a deaeration machine to perform dark deaeration for 3 hours.

Similarly, the sealant is placed in a deaeration machine to perform dark deaeration for 4 hours before use.

### Embodiment 9

The difference between the embodiment 9 and the embodiment 8 includes that: in the embodiment 9, the UV absorption pigment is coated at a non-mask coverage area in a form of a ring; the width of the UV absorption pigment is 10 μm, and the thickness of the UV absorption pigment is 5 μm; and the distance from the UV absorption pigment to the sealant is 50 μm.

In the embodiment, before coating, the UV absorption pigment and dichloromethane are uniformly mixed according to the mass ratio (or volume ratio) of 50% to 50% and are placed in a deaeration machine to perform dark deaeration for 2 hours respectively; and the sealant is placed in a deaeration machine to perform dark deaeration for 3 hours before use.

### Embodiment 10

The difference between the embodiment 9 and the embodiment 10 includes that: in the embodiment 10, the UV absorption pigment is coated at a mask coverage area in a form of strips (a symmetric two-side strip coating); the width of the UV absorption pigment strip is 20 μm, and the thickness of the UV absorption pigment strip is 2 μm; and the distance from the UV absorption pigment strip to the sealant is 200 μm.

In the embodiment, before coating, the UV absorption pigment and trichloromethane are uniformly mixed according to the mass ratio (or volume ratio) of 60% to 40% and placed in a deaeration machine to perform dark deaeration for 2.5 hours respectively; and the sealant is placed in a deaeration machine to perform dark deaeration for 3.5 hours before use.

### Embodiment 11

The difference between the embodiment 11 and the embodiment 8 includes that: in the embodiment 11, the UV absorption pigment is coated at both a non-mask coverage area and a mask coverage area in a form of a ring; the widths of the UV absorption pigment rings are respectively 35 and 15 μm, and the thickness of each UV absorption pigment ring is 4 μm; the distance from the UV absorption pigment ring at the non-mask coverage area to the inner edge of the sealant is 60 μm; and the spacing between the two UV absorption pigment rings is 50 μm.

### Embodiment 12

The difference between the embodiment 12 and the embodiment 8 includes that: in the embodiment 12, the deaeration time of the UV absorption pigment is 1 hour, and the deaeration time of the sealant is 5 hours.

### Embodiment 13

The embodiment provides a display device, which includes any one of the foregoing LCD panels. The display device may be any product or component with display functions including a TV, a display, a mobile phone, a tablet PC, a digital picture frame, a camera, a video camera, a navigator or an e-book.

It should be noted that, in the drawings, the size of a layer or an area may be exaggerated for clarity of the drawings. Besides, it is understandable that if an element or a layer is said to be “under” another element or layer, it can be directly under the other element or an intermediate layer may exist therebetween. Besides, it is understandable that if a layer or an element is said to be “between” two layers or “between” two elements, it can be the only one layer or element between the two layers or two elements, or one or more intermediate layer or element can exist. Similar reference marks in the full text refer to the similar elements.

In the present disclosure, the terms “first,” “second,” “third”, etc. are not intended to indicate or imply any importance, but merely used for description purposes. The term “plurality” refers to two or more than two, unless otherwise defined.

The foregoing are merely specific embodiments of the invention, but not limitative to the protection scope of the invention. One skilled in the art could devise variations or replacements that within the scope and the spirit of the present invention, those variations or replacements shall belong to the protection scope of the invention. Thus, the protection scope of the invention shall be defined by the accompanying claims.

The application claims priority to the Chinese patent application No. 201510266493.8, filed May 22, 2015, the disclosure of which is incorporated herein in its entirety by reference as part of the application.

What is claimed is:

1. A liquid crystal display (LCD) panel, comprising an upper substrate, a lower substrate, liquid crystal molecules filled in a liquid crystal (LC) display area between the upper substrate and the lower substrate, and sealant sealed at edges of the upper substrate and the lower substrate, wherein ultraviolet (UV) absorption pigment configured for preventing UV light from entering into the LC display area is coated between the sealant and the LC display area.

2. The LCD panel according to claim 1, wherein the UV absorption pigment is coated in a form of a strip or a ring.

3. The LCD panel according to claim 1, wherein the UV absorption pigment includes (E)-6-(4-(4-(ethane-sulfonyl)styryl)phenoxy)ethane-1-alcohol.

4. The LCD panel according to claim 1, wherein a coating width of the UV absorption pigment is 10 to 100 μm, and a thickness of the UV absorption pigment is 2.0 to 6.0 μm.

5. The LCD panel according to claim 4, wherein a distance from a coating position of the UV absorption pigment to the sealant is greater than or equal to 50 μm.

6. The LCD panel according to claim 1, wherein the UV absorption pigment is coated at a mask coverage area between the sealant and the LC display area.

7. A method for manufacturing an LCD panel, comprising: arranging an upper substrate and a lower substrate of the LCD panel, and forming the LCD panel by assembling the upper substrate and the lower substrate together, wherein:
the upper substrate and the lower substrate are arranged opposite to each other, liquid crystal molecules are disposed in an liquid crystal (LC) display area between the upper substrate and the lower substrate, and sealant is sealed at edges of the upper substrate and the lower substrate; and
the method further comprises: before the assembling, coating UV absorption pigment between the sealant and the LC display area, the UV absorption pigment configured for preventing UV light from entering into the LC display area.

8. The manufacturing method according to claim 7, wherein the UV absorption pigment includes (E)-6-(4-(4-(ethane-sulfonyl)styryl)phenoxy)ethane-1-alcohol.

9. The manufacturing method according to claim 8, wherein the UV absorption pigment is coated after being dissolved in an organic solvent.

10. The manufacturing method according to claim 9, wherein the organic solvent includes one or more of dichloromethane, trichloromethane and acetone.

11. The manufacturing method according to claim 9, wherein a mixed mass ratio of the UV absorption pigment to the organic solvent is in a range between 1:9 and 6:4.

12. The manufacturing method according to claim 7, further comprising performing deaeration on the sealant and the UV absorption pigment before use.

13. A display device, comprising the LCD panel according to claim 1.

14. The LCD panel according to claim 1, wherein the UV absorption pigment is coated at a non-mask coverage area between the sealant and the LC display area.

15. The LCD panel according to claim 1, wherein the UV absorption pigment is coated at both a mask coverage area and a non-mask coverage area between the sealant and the LC display area.

16. The LCD panel according to claim 2, wherein a coating width of the UV absorption pigment is 10 to 100 μm, and a thickness of the UV absorption pigment is 2.0 to 6.0 μm.

17. The LCD panel according to claim 3, wherein a coating width of the UV absorption pigment is 10 to 100 μm, and a thickness of the UV absorption pigment is 2.0 to 6.0 μm.

18. The LCD panel according to claim 2, wherein the UV absorption pigment is coated at a mask coverage area between the sealant and the LC display area.

19. The LCD panel according to claim 2, wherein the UV absorption pigment is coated at a non-mask coverage area between the sealant and the LC display area.

20. The LCD panel according to claim 1, wherein the UV absorption pigment includes a first UV absorption pigment ring and a second UV absorption pigment ring which are coated at a mask coverage area and a non-mask coverage area between the sealant and the LC display area, respectively.
